(19) United States
(12) Patent Application Publication
(10) Pub. No.: US 2004/0163891 A1
(43) Pub. Date: Aug. 26, 2004

(54) Stepladder accessory tray

(76) Inventors: David Lee Craig, Hendersonville, NC (US); Terry Lee Craig, Asheville, NC (US)

Correspondence Address: John B. Hardaway, III, NEXSEN PRUET JACOBS & POLLARD, LLC, P.O. Box 10107, GreenVille, SC, 29603-0107, US

(21) Appl. No.: 10/373,419

(22) Filed: Feb. 24, 2003

(51) Int. Cl. E06C 5/32

(52) U.S. Cl. 182/129; 248/238

(57) ABSTRACT

A utility tray for use with a stepladder. The utility tray comprises a void for receiving the stepladder there through. The void comprises a front rail which contacts a first pair of coplanar ladder stile and a rear rail which contacts a second pair of coplanar ladder stiles. A platform is attached to the front rail. A pair of side rails attach the front rail to the handle.

### BACKGROUND OF THE INVENTION

The present invention relates to an accessory tray particularly suitable for use with a stepladder. More specifically, the present invention relates to an accessory tray which receives the ladder and rest on the stiles of the ladder without disrupting the stability of the stepladder.

Overhead work has long been aided by the use of ladders. Stepladders are a common tool for any operation requiring the person to reach overhead including such diverse activities as painting, plumbing, electrical work, woodwork, etc. One common problem associated with working on a ladder is the inaccessibility of tools of the trade. Virtually all forms of working on a ladder require some type of tool or part. Retrieving tools, or parts, while on a ladder has been an ongoing problem. Furthermore, most operations require multiple tools. It is not uncommon for the person working on the ladder to make repeated trips up and down a ladder to access the proper tools. This leads to fatique and increases the likelihood of injury.

Trays, adapted to ladders, are known in the art. Many stepladders comprise a fold out tray that is pivotally attached to a rung of the ladder on one side. As the stiles of the ladder are separated the tray folds out. These trays are typically small to allow them to fit within the stiles when folded. Due to the size limitation the foldable trays hold a minimal number of tools. A larger tray would not fit within the stiles and is therefore contrary to the desire to have a compact folded ladder. A tray, attachable to a standard fold out tray, is described in U.S. Pat. No. 6,341,666. While an improvement, this tray must be installed and removed by turning a threaded member under the tray while also holding the tray in place to insure it does not fall. This two handed operation does not leave a hand for holding onto the ladder. This is undesirable.

Other attachable trays are described in the art. Attachable trays can be categorized into three groups. One type attaches to a rung similar to the fold out tray described above. The second type attaches to the top of the ladder and the third type attaches to the stiles. Trays attachable to the rung are exemplified in U.S. Pat. No. 4,016,955. These offer little improvement over the fold out trays. Due to the size restrictions these provide no more storage area than the folding trays. This solution has never received wide spread acceptance in the art.

Trays attachable to the top of the ladder are described in U.S. Pat. Nos. 6,131,699; 5,967,259 and 5,941,344. These are an improvement over fold out trays yet they are typically unstable. Heavy weights tend to cause the trays to become disconnected which is undesirable.

Trays attachable to the stiles have been determined to provide the best stability as exemplified in U.S. Pat. No. 4,730,802. Unfortunately, the weight is outside of the footprint of the ladder and offset to one side. This is dangerous. A weight extending outside of the footprint of a ladder decreases the stability of the ladder. An apron is described in U.S. Pat. No. 5,647,453 which does not extend beyond the footprint of the ladder yet this apron has limited utility and requires multiple straps. Furthermore, the apron encases the upper extent of the ladder. The upper extent of the ladder, particularly the top of the ladder, are typically used to hold onto the ladder. If one using the apron became unstable the apron would prohibit the user from reaching out to grab the top step as commonly done. Eliminating the top step as a handle is detrimental to the safe use of a ladder.

### BRIEF SUMMARY OF THE INVENTION

It is object of the present invention to provide a utility tray for use with a stepladder which is convenient, easily installed and removed, and which can hold a substantial weight without extending beyond the footprint of the ladder.

It is another object of the present invention to provide a utility tray for a ladder which can be easily installed with one hand thereby leaving one hand for holding onto the ladder.

A particular feature of an embodiment of the present invention is the ability to incorporate tools into the tray thereby increasing the utility of the utility tray.

Another particular feature is the incorporation of a carrying handle for use when the utility tray is not being used with a ladder.

These and other advantages, as would be realised to one of ordinary skill in the art, are provided in a utility tray for use with a stepladder. The utility tray comprises a void for receiving the stepladder there through. The void comprises a front rail which contacts a first pair of coplanar ladder stiles and a rear rail which contacts a second pair of coplanar ladder stiles. A platform is attached to the front rail. A pair of side rails attach the front rail to the handle.

Another embodiment is provided in a utility tray for use with a stepladder. The utility tray comprises a platform and a void for receiving the stepladder there through. The void comprises a front rail which contacts a first pair of coplanar ladder stile and a rear rail which contacts a second pair of coplanar ladder stiles. The front rail comprise a rail interior surface wherein the rail interior surface is at the same angle relative to the platform as the first pair of coplanar ladder stiles. The rear rail comprise an interior handle surface wherein the interior handle surface is at the same angle relative to the platform as the second pair of coplanar ladder stiles. The platform is attached to the front rail. A pair of side rails attachs the front rail to the handle.

### BRIEF DESCRIPTION OF THE DRAWINGS

FIG. 1 is a top perspective view of an embodiment of the present invention.

FIG. 2 is a cross-sectional view taken along line 2-2 of FIG. 1.

FIG. 3 is a top view of an embodiment of the present invention.

FIG. 4 is a top perspective view of an embodiment of the present invention.

### DETAILED DESCRIPTION OF THE INVENTION

The inventors of the present application have developed, through diligent research, a utility tray for use with a stepladder. The utility tray eliminates the deficiencies currently existing in the art.

The invention will be described with reference to the figures forming a part of the present application. In the various figures similar elements are numbered accordingly.

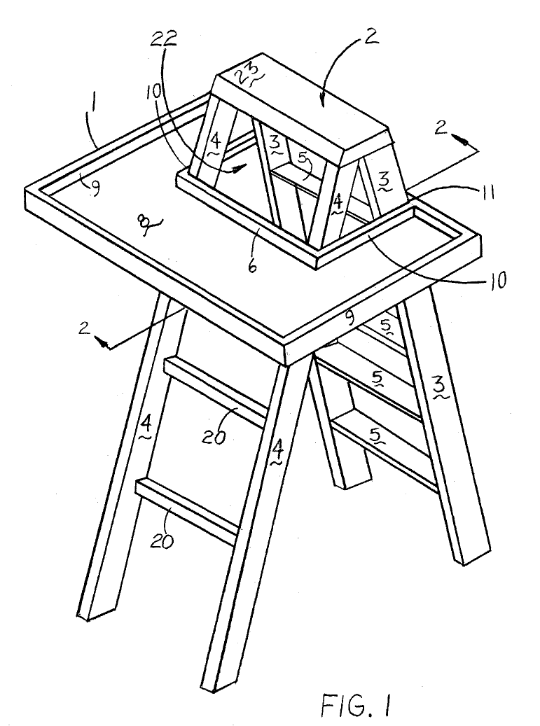

An embodiment of the present invention is illustrated in FIG. 1. In FIG. 1, the utility tray, generally represented at 1, receives a ladder, generally represented at 2 which protrudes through the utility tray. The utility tray, 1, comprises a centrally located ladder receiving void, 22, within which the stepladder is received. The stepladder comprises coplanar rear stiles, 3, with steps, 5, there between, and coplanar forward stiles, 4, with stabilizers, 20, there between. The upper extent of the rear stiles and forward stiles are pivotally attached to a ladder top, 23. The utility tray comprises a platform, 8, upon which tools and the like are placed. Optional, but preferred are rails to insure that tools do not fall off of the platform during use. The rails preferably comprise a front rail, 7, side rails, 9, and rear rail, 6. The utility tray receives the ladder till the rear rail, 6, and handle, 11, contact the forward stiles, 4 and rear stiles, 3, respectively. Side rails, 10, connect the handle, 11, to the remainder of the tray and insure that the try does not slide sideways. The handle, 11, provides the added benefit of a convenient location for grasping the tray during transport or for hanging the tray when not in use.

A particular feature of the inventive utility tray is that the downward projection of the utility tray is within the footprint of the ladder. The footprint is the widest and longest extent of the ladder as indicated by the dotted lines. Stepladders typically flair outward for stability and the length and width of the tray is preferably within the broadest extent of the ladder.

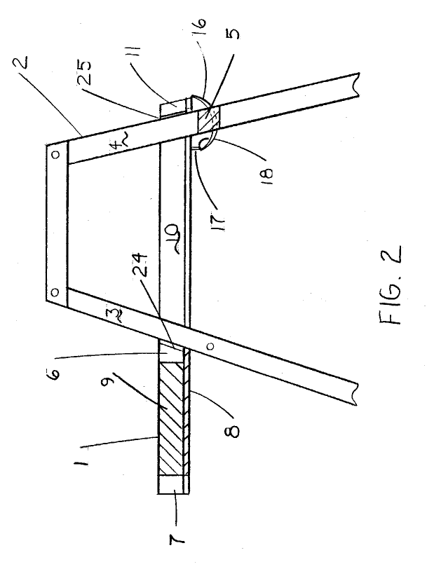

A cross-sectional view of the embodiment taken along line 2-2 of FIG. 1 is provided in FIG. 2. The rear rail, 6, comprises a rail interior surface, 24, which forms an angle relative to the plane of the platform, 8, that is the same as the front stiles, 4, such that the rail interior surface, 24, is flush with the front stiles. In a similar fashion, the handle, 11, comprises a handle interior surface, 25, which is at the same angle relative to the platform as the rear stile, 3. This provides maximum contact between the contacting surface of the utility tray and the ladder stiles thereby greatly increasing the stability of the utility tray. The stiles are typically at an angle of about 70-80° relative to the ground. In a particularly preferred embodiment the rear rail is at an angle of about 72° and the front stiles are at an angle of about 80°.

A strap, 16, attached to the utility tray, preferably at the handle, 11, preferably wraps around a step, 5, of the ladder, 2, to further stabilize the utility tray. In one embodiment, the strap, 16, wraps around the step, 5, and through a loop, 17, to be secured to itself by an attachment element, 18. Preferred attachment elements include hook and loop systems, such as Velcro®, snaps, belt buckles, spring loaded cams, and the like. The attachment element is any element, or combination of elements suitable for securing a strap to itself. The utility tray could also be secured with multiple straps that attach to each other by an attachment element but a single strap and loop is preferred for simple, one handed operation. Multiple single straps may be employed if so desired. A stretchable cable, with attached hooks, may be employed to secure the tray to the ladder.

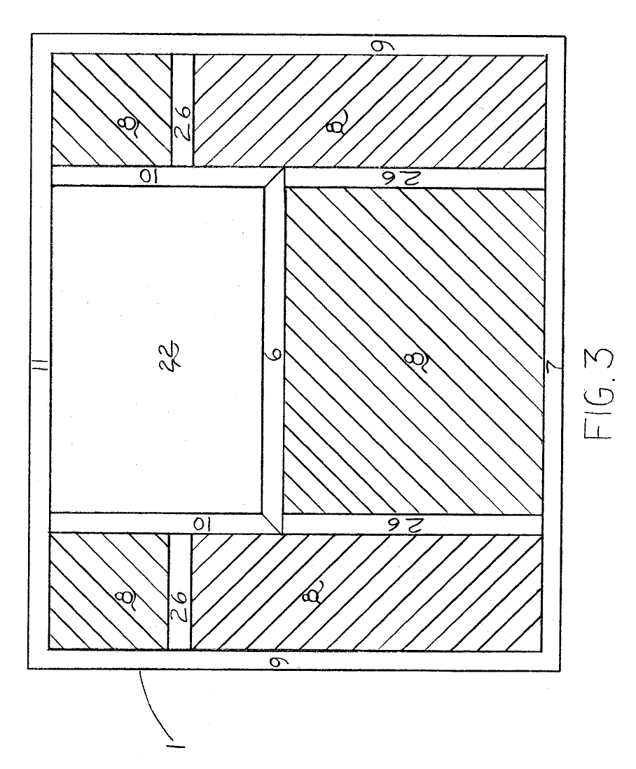

An embodiment of the present invention is illustrated in FIG. 3. In FIG. 3, the utility tray, 1, comprises a multiplicity of platforms, 8, each separated by an interior rail, 26. The interior rails, 26, may be fixed or they may be modular and easily relocated to increase or decrease the number of platform areas or to change the size of given areas. Platform areas beside the void, 22, are illustrated. As described herein, it is most preferred that the overall width of the utility tray be no more than the footprint of the stepladder. This is typically wider than the top portion of the ladder received by and protruding through the void, 22.

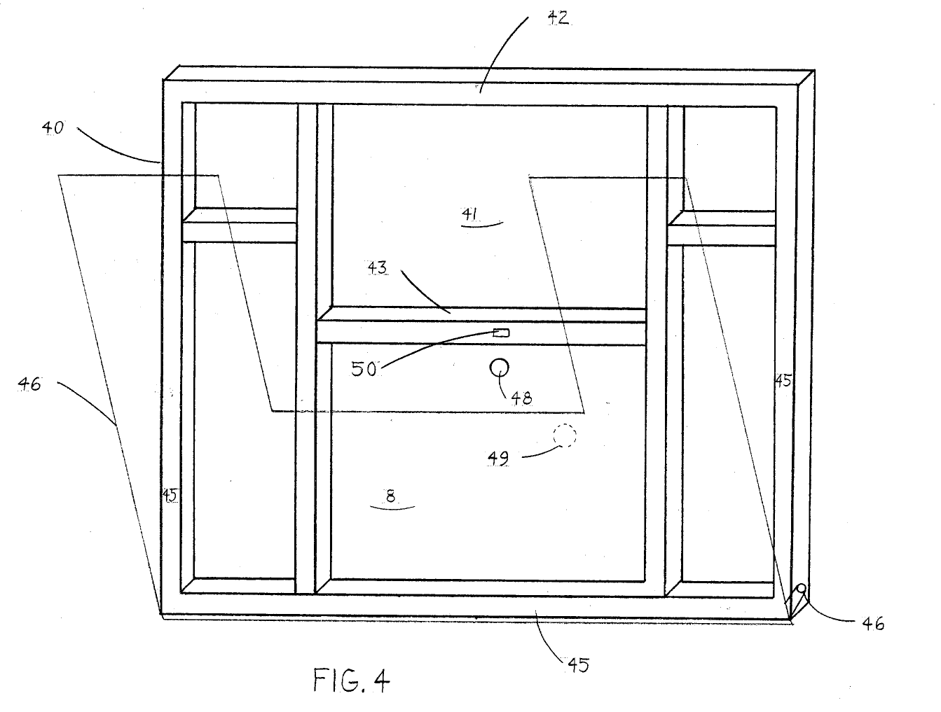

A particularly preferred embodiment is provided in FIG. 4. In FIG. 4, a utility tray, 40, comprises a ladder void, 41, wherein the ladder is received as described herein. The ladder void, 41, comprises a handle, 42. The handle interior surface, 43, is at the same angle, relative to the surface of the tray, as the coplanar ladder stiles as describe previously. The platform, 44, is surrounded by a raised rail, 45. A cover, 46, preferably pivotally attached to the utility tray by a pivot, 46, covers the platform, 44, or is easily rotated away from the platform whereby tools, 47, can be accessed. In this preferred embodiment the utility tray encases the tools, and provides a work platform when used on a ladder. Optional, but preferred, tool holsters, 48, can be provided wherein tools can be easily stored and retrieved. In one embodiment, the tool holsters are voids though which tools are partially passed and secured therein by the cover, 46. In one embodiment the platform has impressions, or protrusions, within which tools are retained by friction fit. An optional, but preferred latch system, 49 and 50, reversibly secures the cover in a closed relationship with the platform of the utility tray.

The invention has been described with particular emphasis on the preferred embodiments. It would be realized from the teachings herein that other embodiments, alterations, and configurations could be employed without departing from the scope of the invention which is more specifically set forth in the claims which are appended hereto.

Claimed is:

1. A utility tray for use with a stepladder comprising:
a void for receiving said stepladder there through wherein said void comprises a front rail which contacts a first pair of coplanar ladder stiles and a rear rail which contacts a second pair of coplanar ladder stiles;
a platform attached to said front rail;
a pair of side rails attaching said front rail to said handle.

2. The utility tray of claim 1 wherein said front rail comprise a rail interior surface wherein said rail interior surface is at the same angle relative to said platform as said first pair of coplanar ladder stiles.

3. The utility tray of claim 1 wherein said rear rail comprise an interior surface wherein said interior surface is at the same angle relative to said platform as said second pair of coplanar ladder stiles.

4. The utility tray of claim 1 wherein said utility tray further comprises an attachment for securing said tray to said ladder.

5. The utility tray of claim 4 wherein said attachment secures said tray to a step of said ladder.

6. The utility tray of claim 1 wherein said utility tray further comprises a cover.

7. The utility tray of claim 6 wherein said cover is pivotally attached to said utility tray.

8. The utility tray of claim 1 wherein said utility tray comprises a projection and said projection is smaller than a footprint of said ladder.

9. The utility tray of claim 1 further comprising a rail around said platform.

10. The utility tray of claim 1 wherein said rear rail is a handle.

11. A utility tray for use with a stepladder comprising:
a platform attached to a front rail;
a void for receiving said stepladder there through wherein said void comprises said front rail which contacts a first pair of coplanar ladder stile and a rear rail which contacts a second pair of coplanar ladder stiles wherein said front rail comprise a rail interior surface wherein said rail interior surface is at the same angle relative to said platform as said first pair of coplanar ladder stiles and wherein said rear rail comprise an interior surface wherein said interior surface is at the same angle relative to said platform as said second pair of coplanar ladder stiles;
a pair of side rails attaching said front rail to said handle.

12. The utility tray of claim 11 wherein said utility tray further comprises an attachment for securing said tray to said ladder.

13. The utility tray of claim 12 wherein said attachment secures said tray to a step of said ladder.

14. The utility tray of claim 12 wherein said utility tray further comprises a cover.

15. The utility tray of claim 14 wherein said cover is pivotally attached to said utility tray.

16. The utility tray of claim 11 wherein said utility tray comprises a projection and said projection is smaller than a footprint of said ladder.

17. The utility tray of claim 11 further comprising a rail around said platform.
